(19) United States
(12) Patent Application Publication
(10) Pub. No.: US 2010/0156976 A1
(43) Pub. Date: Jun. 24, 2010

(54) INKJET PRINTER HEAD ARRANGING METHOD AND INKJET PRINTER HEAD ARRANGING APPARATUS

(75) Inventors: Sangchul SEO, Yongin-si (KR); Minhyung Kim, Yongin-si (KR); Younghak Pyo, Yongin-si (KR); Jaeseok Lim, Yongin-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/631,020

(22) Filed: Dec. 4, 2009

(30) Foreign Application Priority Data
Dec. 18, 2008 (KR) 10-2008-0129684

(51) Int. Cl. B41J 29/38

(52) U.S. Cl. 347/14

(57) ABSTRACT

A method and apparatus for arranging heads of an inkjet printer such that ink droplets discharged from respective multiple heads are corrected to zero degrees, X-directional positions of the multiple heads are precisely mechanically arranged, and Y-directional positions of the multiple heads are precisely arranged by software. The inkjet printer head arranging apparatus includes: ink droplet formation units forming ink droplets on a substrate by arranging a plurality of heads in a row and injecting ink to the substrate through the heads; a sensing unit sensing the ink droplets formed on the substrate; a position calculation unit calculating the positions of the sensed ink droplets; a correction value calculation unit calculating position correction values for the heads using the positions of the calculated ink droplets; and a position correction unit correcting the positions of the heads using the calculated position correction values of the heads.

### CROSS-REFERENCE TO RELATED APPLICATION

This application claims the benefit of Korean Patent Application No. 10-2008-0129684, filed Dec. 18, 2008 in the Korean Intellectual Property Office, the disclosure of which is incorporated herein by reference.

### BACKGROUND OF THE INVENTION

1. Field of the Invention

Aspects of the present invention relate to a method and an apparatus for arranging a head of an inkjet printer.

2. Description of the Related Art

In general, in an inkjet printer having a single head, it takes a relatively short time to arrange the head, but a relatively long time to print documents using the head. On the other hand, in an inkjet printer having multiple heads, it takes a relatively long time to arrange the heads but a relatively short time to print documents.

Recently, inkjet printers with multiple heads have come into wide use in which it takes a long time to arrange the heads, the printing time is short, and the printers exhibit high productivity. However, when the multiple heads are not precisely arranged in a regular interval in the X-direction and the respective heads are tilted about their central axes, either relatively thick printed lines or empty lines are formed in printing areas corresponding to boundary areas. Thus, the multiple heads must be precisely arranged at regular intervals in the X-direction and the respective heads must not be allowed to tilt.

### SUMMARY OF THE INVENTION

To address some of these needs, aspects of the present invention provide a method and apparatus for arranging heads of an inkjet printer such that ink droplets discharged from multiple heads are controlled so as to make tilting angles of the respective heads zero degrees (that is, adjusted so there is no tilt between the left and right ink droplets from the respective heads), arranging X-directional positions of the multiple heads precisely in a mechanical way, and arranging Y-directional positions of the multiple heads precisely by software.

An aspect of the present invention provides an inkjet printer head arranging method comprising: forming ink droplets on a substrate by arranging a plurality of heads in a row and injecting ink onto the substrate through the heads; sensing the positions of the ink droplets formed on the substrate; calculating the positions of the sensed ink droplets; calculating position correction values for the heads using the positions of the calculated ink droplets; and correcting the positions of the heads using the calculated position correction values of the heads.

In sensing the positions of the ink droplets, the Y-directional positions of ends of the ink droplets corresponding to one head may be measured. In sensing the positions of the ink droplets, the Y-directional positions of facing ends of the ink droplets in two regions corresponding to adjacent heads may be measured. In sensing the positions of the ink droplets, the X-directional positions of facing ends of the ink droplets in two regions corresponding to adjacent heads may be measured.

In calculating the positions of the heads, at least one of the tilting angle, the Y-directional position, and the X-directional position of the captured ink droplets may be calculated. In calculating the positions of the heads, the tilting angle of the ink droplets may be calculated by calculating the Y-directional positions of ink droplet positions at opposite ends of one ink droplet formation unit. In calculating the positions of the heads, a Y-directional height difference between ink droplets of two adjacent ink droplet formation units may be calculated by calculating Y-directional positions of facing ends of the ink droplets of the two adjacent ink droplet formation units.

In calculating the positions of the heads, the X-directional distance between ink droplets of two adjacent ink droplet formation units may be calculated by calculating X-directional positions of facing ends of the ink droplets of the two adjacent ink droplet formation units. In calculating position correction values of the heads, at least one of the tilting angles, Y-directional positions, and X-directional positions of the heads may be calculated.

In correcting the positions of the heads, at least one of the tilting angles and X-directional positions of the heads may be corrected. In correcting the positions of the heads, the Y-directional positions of the heads may be corrected by making the injection times of the heads different.

Another aspect of the present invention provides an inkjet printer head arranging apparatus comprising: an ink droplet formation unit forming ink droplets on a substrate by arranging a plurality of heads in a row and injecting ink to the substrate through the heads; a sensing unit sensing the ink droplets formed on the substrate; a position calculation unit calculating the positions of the captured ink droplets; a correction value calculation unit calculating position correction values for the heads using the positions of the calculated ink droplets; and a position correction unit correcting the positions of the heads using the calculated position correction values of the heads.

The sensing unit may sense the Y-directional positions of ends of the ink droplets corresponding to one head. The sensing unit may sense the Y-directional positions of facing ends of the ink droplets in two ink droplet formation units corresponding to adjacent heads. The sensing unit may capture the X-directional positions of facing ends of the ink droplets in two ink droplet formation units corresponding to adjacent heads.

The position calculation unit may calculate at least one of the tilting angle, the Y-directional position, and the X-directional position of the sensed ink droplets from one or adjacent heads. The position calculation unit may calculate the tilting angle of the ink droplets by calculating the Y-directional positions of opposite ends of one ink droplet. The position calculation unit may calculate the Y-directional height difference between ink droplets of two adjacent ink droplet formation units by calculating Y-directional positions of facing ends of the ink droplets of the two adjacent ink droplet formation units. The position calculation unit may calculate the X-directional distance between ink droplets of two adjacent ink droplet formation units by calculating X-directional positions of facing ends of the ink droplets of the two adjacent ink droplet formation units.

The correction value calculation unit may calculate one or more of the necessary corrections from the tilting angles, Y-directional positions, and X-directional positions of the heads that are calculated from the positions of the ink droplets. The position correction unit may correct at least one of the tilting angles and X-directional positions of the heads. Y-directional positions are corrected by adjusting the time of injection of ink from the ink droplet formation units of each head.

Therefore, according to aspects of the present invention, ink droplets discharged from multiple heads are controlled so as to make tilting angles of the respective heads zero degrees (that is, adjusted so there is no tilt between the left and right ink droplets from the respective heads), X-directional positions of the multiple heads are precisely arranged in a mechanical way, and Y-directional positions of the multiple heads are precisely arranged by software.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are front and rear perspective views respectively illustrating the mechanical configuration of an inkjet printer head arranging apparatus according to an embodiment of the present invention;

FIG. 1C is a bottom view illustrating the bottom of a head of the inkjet printer according to this embodiment of the present invention;

FIG. 2 is a block diagram illustrating a control unit for the inkjet printer head arranging apparatus according to this embodiment of the present invention;

FIG. 3 is a flowchart illustrating a method of arranging a head of an inkjet printer according to another embodiment of the present invention;

FIG. 4 illustrates ink droplets with tilting angles sensed by a sensing unit during the performance of the inkjet printer head arranging method according to another embodiment of the present invention;

FIG. 5 illustrates ink droplets with a Y-directional height difference captured by the sensing unit during the performance of the printer head arranging method according to another embodiment of the present invention;

FIG. 6 illustrates ink droplets with an X-directional distance difference sensed by the sensing unit during the performance of the printer head arranging method according to another embodiment of the present invention; and

FIGS. 7A to 7D are views illustrating a sequence of printing patterns on a substrate using the heads of an inkjet printer according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

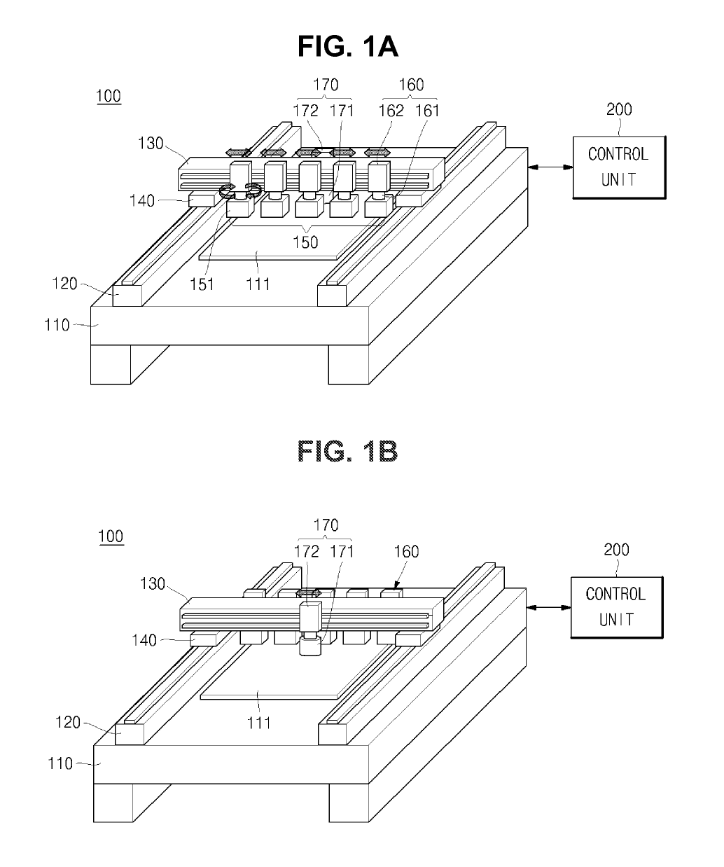

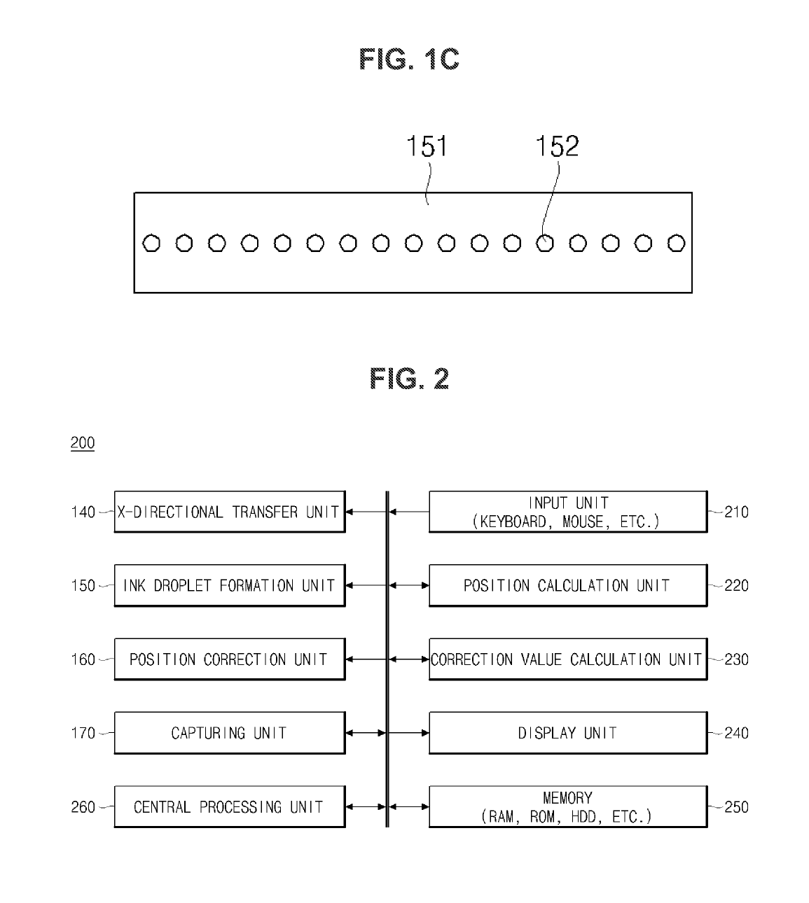

FIGS. 1A and 1B are front and rear perspective views respectively illustrating the mechanical configuration of an inkjet printer head arranging apparatus according to an embodiment of the present invention. FIG. 1C is a bottom view illustrating the bottom of a head of the inkjet printer according to this embodiment of the present invention. As illustrated in FIGS. 1A and 1B, the inkjet printer head arranging apparatus 100 includes a stage 110, main guide rails 120, a sub-guide rail 130, Y-directional transfer units 140, an ink droplet formation unit 150, position correction units 160, capturing units 170, and a control unit 200.

The stage 110 has a substantially flat top surface and a substrate 111 to be printed is located on the top surface of the stage 110. Here, the substrate 111 may be an LCD substrate, a PDP substrate, or an OLED substrate, but the present invention is not limited thereto. In other words, paper, cloth or plastic may be located on the top of the stage 110 instead of the substrate 111. In addition, at least one article selected from a color filter, an electromagnetic shield filter, a black matrix, an organic thin film, an inorganic thin film, and their equivalents may be printed on the substrate 111, but the present invention is not limited thereto.

The main guide rails 120 are formed on the top of the stage 110. The main guide rails 120 extend from the front side to the rear side of the stage 110 (i.e. in the Y-direction). A pair of main guide rails 120 is spaced apart from each other by a distance. The substrate 111 is located between the two main guide rails 120.

The sub-guide rail 130 is located over the main guide rails 120 in a direction substantially perpendicular to the main guide rails 120 (i.e., in the X-direction). The sub-guide rail 130 is transferred along the main guide rails 120. Here, the transfer direction of the sub-guide rail 130 is defined as the Y-direction.

The Y-directional transfer unit 140 is mounted between the main guide rails 120 and the sub-guide rail 130. The Y-directional transfer units 140 move the sub-guide rail 130 in the Y-direction on the main guide rails 120. The Y-directional transfer units 140 are generally guide blocks attached to the sub-guide rail 130.

Here, the assembled structure of the main guide rails 120, the sub-guide rail 130, and the Y-directional transfer units 140 are illustrated only to help understanding of the present invention, but the present invention is not limited by the drawings. In other words, in addition to the above-mentioned structure, various mechanisms such as a drive motor and a conveyer belt, and a drive motor and a transfer screw can be additionally employed, and it is apparent that those skilled in the art can easily conceive other mechanisms.

As illustrated in FIG. 1C, the ink droplet formation unit 150 includes a plurality of heads 151 arranged in a row and spaced apart from each other by a distance (reference distance). In other words, the ink droplet formation unit 150 has multiple heads or a head array. Each head 151 has a substantially rectangular shape, and a plurality of injection nozzles 152 are formed on the bottom surface in at least one row in the X-direction. Ink is injected on the substrate 111 substantially through each injection nozzle 152. The heads 151 are spaced apart by a distance which corresponds to the X-directional length of one injection nozzle 152.

The position correction units 160 are mounted between the ink droplet formation unit 150 and the sub-guide rail 130. In other words, each position correction unit 160 includes a rotation unit 161 rotating the head 151 of the ink drop formation unit 150 by an angle and an X-directional transfer unit 162 transferring the head of the ink drop formation unit 150 in the X-direction. The position correction units 160 may be at least one article selected from a motor, a cylinder, and their equivalents, but the present invention is not limited thereto. The X-directional transfer units 162 of the position correction units 160 are attached to the sub-guide rail 130 to transfer the ink droplet formation unit 150 in the X-direction. The mechanical structures of the rotation units 161 and the X-directional transfer units 162 can be modified by those skilled in the art, and are not limited by the drawings.

The sensing unit 170 is attached to the rear side of the sub-guide rail 130. In other words, the sensing unit 170 is attached to the opposite side of the ink droplet formation unit 150, i.e., on the rear side of the sub-guide rail 130. The sensing unit 170 includes a camera 171 sensing ink droplets formed on the substrate 111 by the ink droplet formation unit 150, and an X-directional transfer unit 172 transferring the camera 171 in the X-direction. The X-directional transfer unit 172 is attached to the sub-guide rail 130 to directly transfer the camera 171 in the X-direction. The X-directional transfer unit 172 may also be a motor, a cylinder, and their equivalents, but the present invention is not limited thereto.

The control unit 200 is electrically connected to the Y-directional transfer units 140, the ink droplet formation unit 150, the position correction units 160, and the sensing unit 170 to directly or indirectly control them. The control unit 200 may be one device selected from a microcomputer, a programmable logic controller (PLC), and their equivalents, but the present invention is not limited thereto.

FIG. 2 is a block diagram illustrating the control unit for the inkjet printer head arranging apparatus according to this embodiment of the present invention. The control unit 200 may include additional elements other than those illustrated in FIG. 2. FIG. 2 illustrates only the essential elements necessary for description of the operation of the inkjet printer arranging apparatus 100. Moreover, for easier understanding of the present invention, the Y-directional transfer units 140, the ink droplet formation unit 150, the position correction units 160, and the sensing unit 170 are included as elements of the control unit 200. FIGS. 1A to 1C will be referred to together with FIG. 2 for understanding of the present invention.

As illustrated in FIG. 2, the control unit 200 includes Y-directional transfer units 140, an ink droplet formation unit 150, position correction units 160, a sensing unit 170, an input unit 210, a position calculation unit 220, a correction value calculation unit 230, a display unit 240, a memory 250, and a central processing unit 260. Here, all the elements of the control unit 200 may be connected to each other by a data bus, but the present invention is not limited thereto.

The Y-directional transfer unit 140 moves the sub-guide rail 130 over the main guide rails 120 in the Y-direction under the control of the central processing unit 260. The central processing unit 260 substantially controls the motors or cylinders for transferring the Y-directional transfer units 140. In other words, if the central processing unit 260 controls the motors or cylinders, the Y-directional transfer units 140 are moved on the main guide rails 120 by a distance. Then, the ink droplet formation unit 150 mounted to the sub-guide rail 130 is transferred in the desired Y-direction by the operation of the Y-directional transfer units 140.

The ink droplet formation unit 150 forms ink droplets on the substrate 111 under the control of the central processing unit 260. In other words, the ink droplet formation unit 150 forms ink droplets on the substrate 111 by applying electrical signals to the injection nozzles 152 of the heads 151.

The position correction units 160 correct the tilting angles and X-directional positions of the heads 151 based on the correction values calculated by the correction value calculation unit 230 under the control of the central processing unit 260. To achieve this, the central processing unit 260 eliminates any tilting angles of the heads 151 by operating the rotation units 161 mounted to the heads 151. In other words, the tilting angles of the heads 151 are made zero degrees (that is, adjusted so there is no tilt between the left and right ink droplets from the respective heads). Meanwhile, the central processing unit 260 moves the heads 151 to the original X-directional positions by operating the X-directional transfer units 162 mounted on the heads 151. In other words, the X-directional distances between the heads 151 are made the X-directional reference distance (the X-directional distance of one head). Then, the tilting angles of the heads 151 are adjusted to zero degrees (as explained above) by the operation of the position correction units 160, and all the X-directional distances between the heads 151 are made the X-directional reference distance. Meanwhile, since the Y-directional positions of the heads 151 can not be directly corrected mechanically, the Y-directional positions of the heads 151 are corrected by controlling the ink injection times of the heads 151 so as to correspond to the Y-directional positions of the heads 151 stored in the memory 250 when a normal printing operation is carried out by the heads 151. It is apparent that the control operation is carried out by the central processing unit 260. This will be described again in the following.

The sensing unit 170 senses ink drops formed on the substrate 111 under the control of the central processing unit 260. In other words, the camera 171 of the sensing unit 170 senses ink droplets formed by the heads 151. In more detail, the camera 171 senses opposite ends of one group of ink droplets. The camera 171 senses all groups of ink droplets formed on the substrate by the heads 151 and transfers the X-directional transfer unit 172 to which the camera 171 is mounted by one length of a head 151 at a time. The operation of the sensing unit 171 occurs after the ink droplet formation unit 150 is moved from the ink droplets by moving the sub-guide rail 130 forward further. Moreover, the image sensed by the sensing unit 170 is displayed on the display unit 240 in real time under the control of the central processing unit 260.

Commands are input to the central processing unit 260 through the input unit 210. In other words, various commands, menus and values may be input through the input unit 210. The input unit 210 may be a keyboard, a mouse, a scanner, and their equivalents, but the present invention is not limited thereto. The position calculation unit 220 automatically calculates the position of the ink droplets sensed by the sensing unit 170 under the control of the central processing unit 260.

As an example, by calculating the Y-directional positions of ink droplets formed by the heads 151, the tilting angles of the ink droplets are automatically calculated. In other words, the leftmost Y-directional position of the ink droplet and the rightmost Y-directional position of the ink droplet are compared with each other. Thereafter, the tilting angle of the head 151 is indirectly calculated using the two Y-directional positions. After the calculation, if the tilting angle is greater than zero degrees (that is, if there is an offset between the Y-direction of a head and the right and left ink droplets of that head), the corresponding head is selected to be rotated.

As another example, the Y-directional positions of the ink droplets formed by adjacent heads 151 are automatically calculated. In other words, the Y-directional position of the rightmost ink droplet formed by one head 151 and the Y-directional position of the leftmost ink droplet formed by another head 151 are compared with each other. Then, the Y-directional height difference of the two heads 151 is indirectly calculated using the two Y-directional positions. After the calculation, if a Y-directional height difference exists, the two heads are considered not to be correctly arranged.

As another example, the X-directional distance between ink droplets formed by adjacent heads 151 is automatically calculated. In other words, the X-directional position of the rightmost ink droplet formed by one head 151 and the X-directional position of the leftmost ink droplet formed by another head 151 are compared with each other. Thereafter, the X-directional distance between the two heads 151 is indirectly calculated using the two X-directional positions. After the calculation, if the distance between the two heads 151 is different from a preset reference distance (the X-directional length of one head 151), the two heads are considered not to be correctly arranged in the X-direction. In other words, the X-directional distance of the two heads 151 needs to be corrected. The correction value calculation unit 230 calculates correction values necessary for the heads 151 based on the positions of the ink droplets calculated by the position calculation unit 220 under the control of the central processing unit 260.

As an example, if tilting angles exist in the ink droplets corresponding to the heads 151, tilting angles necessary for the heads 151 to make the tilting angles of the heads 151 zero degrees are calculated (that is, the angles are calculated that are necessary to adjust the heads 151 so there is no tilt between the left and right ink droplets from the respective heads). The necessary tilting angles are correction values for making the tilting angles between the right and left ink droplets of the heads zero degrees relative to the Y-direction. The correction values are converted to necessary tilting angles of the rotation units 161 of the position correction units 160.

As another example, when the X-directional distance between ink droplets formed by adjacent heads 151 is different from the X-directional reference distance, an X-directional distance necessary for the heads 151 to make the X-directional distance between the ink droplets formed by the adjacent heads 115, the X-directional reference distance is calculated. The X-directional distance necessary for the heads 151 is the correction value for setting the heads to the X-directional distance reference. The correction value is converted to a necessary X-directional distance of the X-directional transfer unit 162 of the position correction unit 160.

As another example, if a height difference exists between the Y-directional positions of ink droplets formed by adjacent heads 151, the ink injection time for allowing the ink droplets injected from all the heads to be formed linearly with a horizontal orientation is calculated in spite of the Y-directional height difference. In other words, since a component for correcting the Y-directional height difference of the heads 151 does not exist, the Y-directional height difference of the heads 151 cannot be corrected sufficiently mechanically. This is because only the rotation units 161 and the X-directional transfer units 162 for correcting the tilting angles and the X-directional positions of the heads 151 are part of this embodiment. Although the sub-guide rail 130 for transferring the ink formation unit 150 along the Y-direction exists, since the sub-guide rail 130 transfers all the heads 151 collectively, the Y-directional height difference of a specific head 151 cannot be corrected in this embodiment. Hence, according to this embodiment of the present invention, where a head 151 deviates from the Y-directional reference position, all the heads 151 are indirectly arranged in a row by regulating the ink injection time. To achieve this, after the Y-directional position of the head 151 that deviated from the Y-directional reference position is stored in the memory 250, the ink injection time of the head 151 is properly controlled with reference to the Y-directional position of the head 151 in a subsequent normal printing process. For example, when a specific head 151 protrudes further in the Y-direction than the other heads 151, the injection time for the ink injected through the head 151 is controlled to be faster or slower than the ink injection time of the ink injected through the other heads 151 as if the head 151 were corrected located in the Y-direction.

The display unit 240 displays the image of the ink droplet captured by the capturing unit 170 and also displays the position calculation state, the correction value calculation state, and the position correction state under the control of the central processing unit 260. The memory 250 temporarily or permanently stores various data or transfers stored data to the central processing unit 260 under the control of the central processing unit 260. Programs performing various control operations are stored in the memory 250. The memory 250 may be a RAM, a ROM, a hard disk, a flash memory, or a compact disk, but the present invention is not limited thereto.

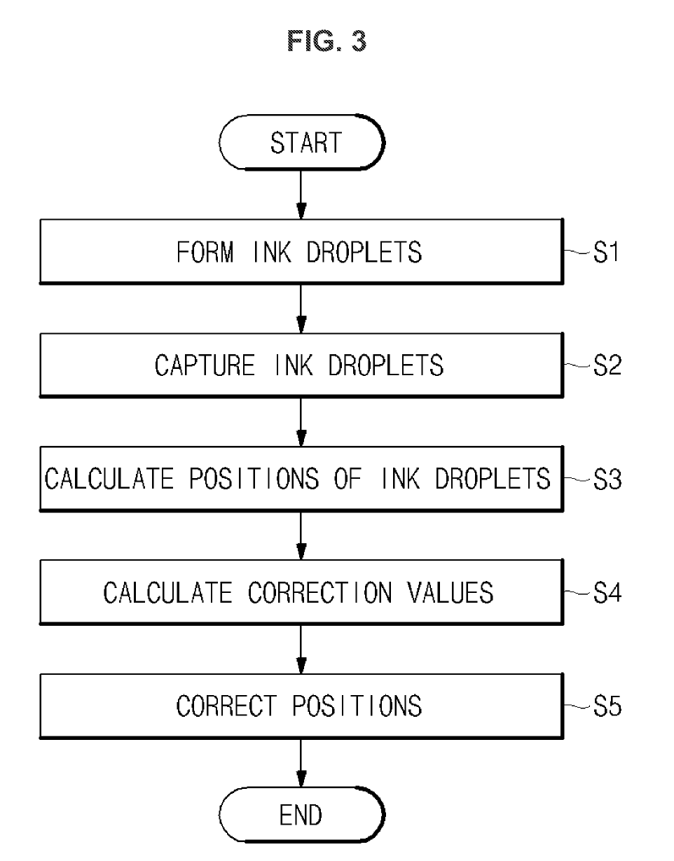

FIG. 3 is a flowchart illustrating a method of arranging a head of an inkjet printer according to another embodiment of the present invention. As illustrated in FIG. 3, the method for arranging a head of an inkjet printer according to this embodiment of the present invention includes an ink droplet forming operation S1, a sensing operation S2, a position calculating operation S3, a correction value calculating operation S4, and a position correcting operation S5.

In the ink droplet forming operation S1, the central processing unit 260 controls the ink drop forming unit 150 to allow the heads 151 arranged in a row to inject ink on substrate 111, forming a plurality of groups of ink droplets on the substrate 111. To achieve this, the central processing unit 260 controls the Y-directional transfer unit 140 to locate the sub-guide rail 130 in a Y-directional position along the main guide rail 120. Thereafter, the central processing unit 260 controls the ink droplet forming unit 150 to form a plurality of ink droplets on the surface of substrate 111. Here, since the heads 151 are spaced apart from each other by the distance of the X-directional length of one head, the ink droplets formed on the substrate 111 are spaced apart from each other by those distances along the X-direction.

In the sensing operation S2, the central processing unit 260 controls the capturing unit 170 to allow the camera 171 to capture ink droplets formed on substrate 111. To achieve this, the central processing unit 260 controls the Y-directional transfer unit 140 to transfer the sub-guide rail 130 along the main guide rail 120, for example, to the front. In other words, the central processing unit 260 controls the Y-directional transfer unit 140 to locate the sensing unit 170 attached to the rear of the sub-guide rail 130 over the ink droplets.

Thereafter, the central processing unit 260 controls the camera 171 of the sensing unit 170 to sense the ink droplets formed on the surface of substrate 111. After the sensed ink droplet image is processed by the central processing unit 260 (a separate image processing unit may be included), it is displayed on the display unit 240 in real time. The central processing unit 260 transfers image information to the position calculation unit 220.

Here, the central processing unit 260 controls the camera 171 to sense the leftmost Y-directional position and the rightmost Y-directional position of the ink droplets formed by the heads 151. The central processing unit 260 controls the camera 171 to sense ink droplets corresponding to a region between adjacent heads 151, i.e., the rightmost ink droplet of ink droplets on one side and the leftmost ink droplet of ink droplets on the other side. Then, the central processing unit 260 controls the X-directional transfer unit 172 to transfer the camera 171 by specific distances in the X-direction along the sub-guide rail 130.

In the position calculating operation S3, the central processing unit 260 sends image information about ink droplets to the position calculation unit 220 to control the position calculation unit 220 to calculate the positions of the sensed ink droplets. As an example, the position calculation unit 220 calculates the tilting angle of ink droplets, using ink droplet images corresponding to the heads 151. In other words, the position calculation unit 220 calculates the tilting angle of the ink droplets, using the Y-directional positions of the leftmost and rightmost ink droplets formed by one head 151. Then, the tilting angle of the ink droplets is the same as the tilting angle of the head 151.

As another example, the position calculation unit 220 calculates the X-directional distance between ink droplets, using ink droplet images corresponding to adjacent heads 151. In other words, the position calculation unit 220 calculates the X-directional distance between ink droplets, using the X-directional position of the rightmost ink droplet of the ink droplets on one side and the X-directional position of the leftmost ink droplet of the ink droplets on the other side. Then, the X-directional distance between ink droplets is the same as the X-directional distance between heads.

As another example, the position calculation unit 220 calculates a Y-directional height difference of ink droplets using an ink droplet image corresponding to adjacent heads 151. In other words, the Y-directional height difference between ink droplets is calculated using the Y-directional position of the rightmost ink droplet on one side and the Y-directional position of the leftmost ink droplet on the other side. The Y-directional height difference of the ink droplets is the same as the Y-directional height difference between the heads 151.

In the correction value calculating operation S4, the central processing unit 260 sends information about the positions of the ink droplets to the correction value calculation unit 230 to allow the correction value calculation unit 230 to calculate correction values of the heads 151. As an example, the correction value calculation unit 230 calculates a correction value by which the tilting angles of the heads 151 are made zero degrees that is, adjusted so there is no tilt between the left and right ink droplets from any one head 151). In other words, the correction value calculation unit 230 calculates the tilting angle of the tilting unit 161 so that the tilting angles of the heads 151 are eliminated.

As another example, the correction value calculation unit 230 calculates a correction value by which the X-directional positions of the heads 151 are made the reference X-directional position. In other words, the correction value calculation unit 230 calculates a transfer distance of the X-directional transfer unit 162 by which the X-directional distance between the heads 151 is made the reference X-directional distance.

As another example, the correction value calculation value 230 calculates a correction value by which the Y-directional height differences of the heads 151 should be moved. Actually, the Y-directional differences of the heads 151 cannot be mechanically corrected. This is because there is no transfer member for correcting the heads 151 along the Y-direction. Hence, the correction value calculation unit 230 calculates ink injection times corresponding to correction values for the Y-directional height differences of the heads 151 and stores them in the memory 250. In other words, the correction values for the Y-directional height differences of the heads 151 are converted to ink injection times and then are stored in the memory 250. The ink injection times corresponding to the correction values for the Y-directional height differences may be stored in the memory 250 in advance in the form of a separate data table.

In the position correcting operation S5, the central processing unit 260 sends the calculated position correction values of the heads 151 to the position correction unit 160 to allow the position correction unit 160 to correct the positions of the heads 151. As an example, the position correction unit 160 makes the tilting angles of the heads 151 zero degrees (that is, eliminates the tilt) by tilting the tilting units 161 coupled to the heads 161 by the correction values.

As another example, the position correction unit 160 makes the X-directional distance between the heads 151 the reference X-directional distance by transferring the X-directional transfer units 162 coupled to the heads 151 by the correction values along the X-direction. In other words, the X-directional distance between the heads 151 is made the reference X-directional distance.

Meanwhile, the position correction unit 160 cannot correct the Y-directional height differences of the heads 151. In other words, correction of the Y-directional height differences of the heads 151 is carried out when ink is actually injected. For example, the ink droplets injected to the heads 151 arranged in the X-direction form a complete horizontal line by applying the injection times of the heads 151 stored in the memory 250 to the heads 151 when ink is actually injected.

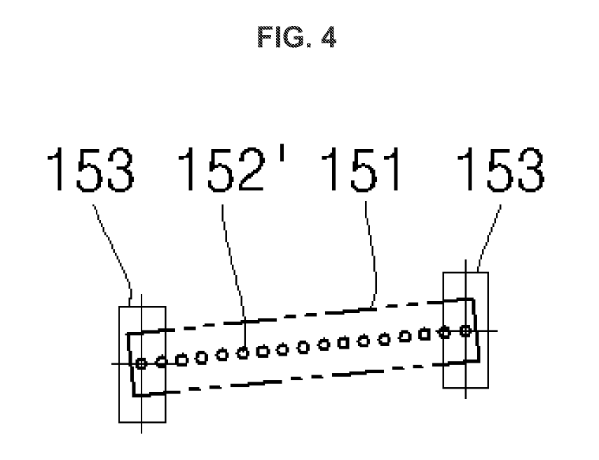

FIG. 4 illustrates ink droplets with tilting angles sensed by a sensing unit during the performance of the inkjet printer head arranging method according to another embodiment of the present invention. In FIG. 4, the dotted lines represent a head 151 forming ink droplets, the points represent ink droplets 152′, and the rectangular boxes having crosses respectively represent sensing regions 153 sensed by the camera 171.

As illustrated in FIG. 4, a difference may occur between the Y-directional positions of the leftmost and rightmost ends of the ink droplets 152′ discharged from one or more heads 151. In order to calculate the tilting angles of the ink droplets 152′, the tilting angles of the heads 151 may be indirectly calculated by measuring the difference between the Y-directional positions of the leftmost and rightmost ends of the ink droplets 152′. The calculated tilting angles are used as correction values for correcting the tilting angles of the heads 151.

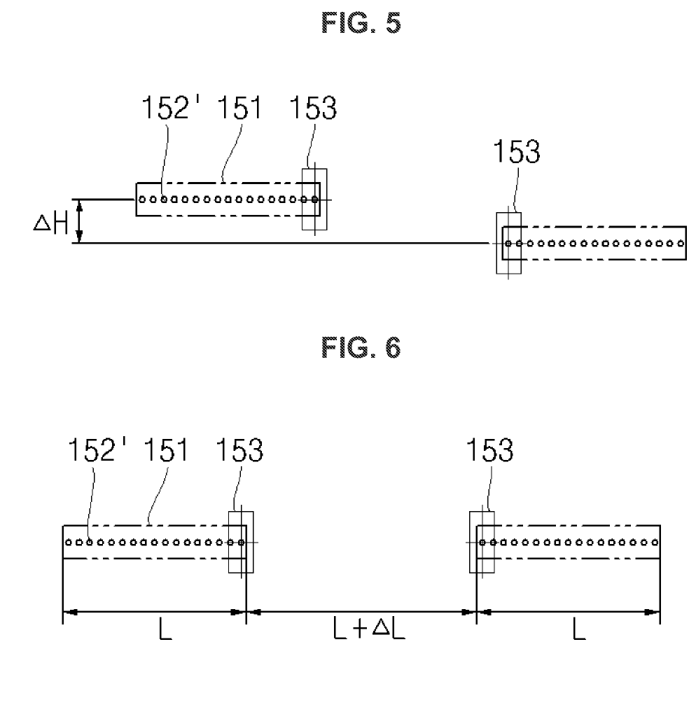

FIG. 5 illustrates ink droplets having a Y-directional difference sensed by the sensing unit in the inkjet printer head arranging method according to this embodiment of the present invention. As illustrated in FIG. 5, a height difference may occur between the Y-directional positions of the ink droplets 152′ discharged from adjacent heads 151. In other words, a height difference ΔH may exist along the Y-direction between adjacent heads 151. The Y-directional height difference ΔH between heads 151 can be corrected by providing different ink injection times to the heads 151 in the normal printing process. As a result, the heads 151 may appear as if they are connected in a row in the X-direction by providing different ink injection times to the heads 151.

FIG. 6 illustrates ink droplets having an X-directional distance sensed by the sensing unit in the inkjet printer head arranging method according to this embodiment of the present invention. As illustrated in FIG. 6, the X-directional distance L+ΔL of the ink droplets 152′ discharged from adjacent heads 151 may be different from an X-directional reference distance L. In other words, the X-directional distance between adjacent heads 151 may be smaller or larger than the X-directional reference distance. That is, the heads 151 may deviate from the X-directional reference position. The X-directional distance L+ΔL between the heads 151 that deviate from the X-directional reference distance may be corrected by adjusting the positions of the heads 151 along the X-direction.

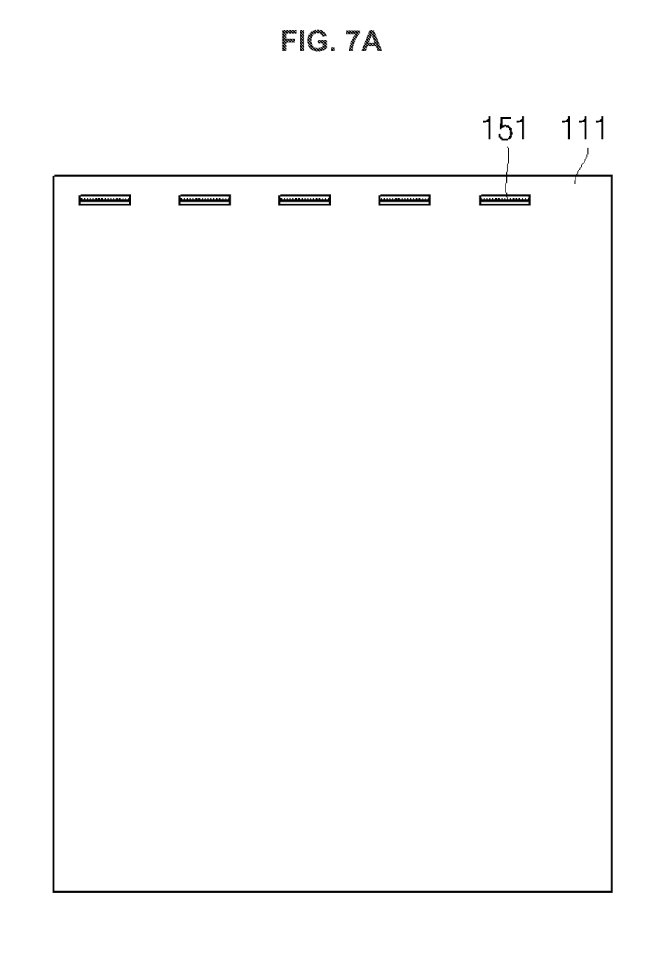

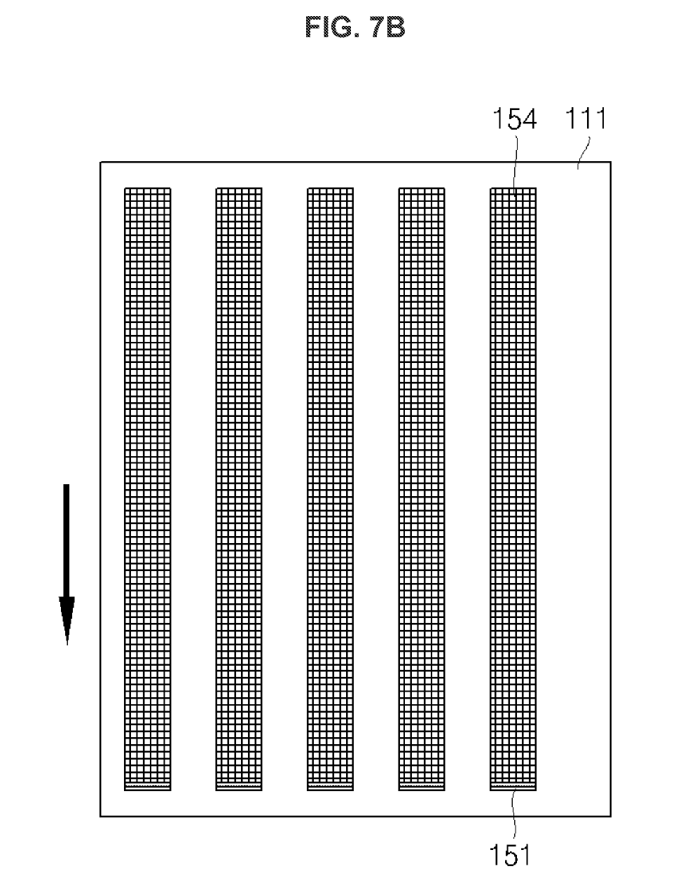

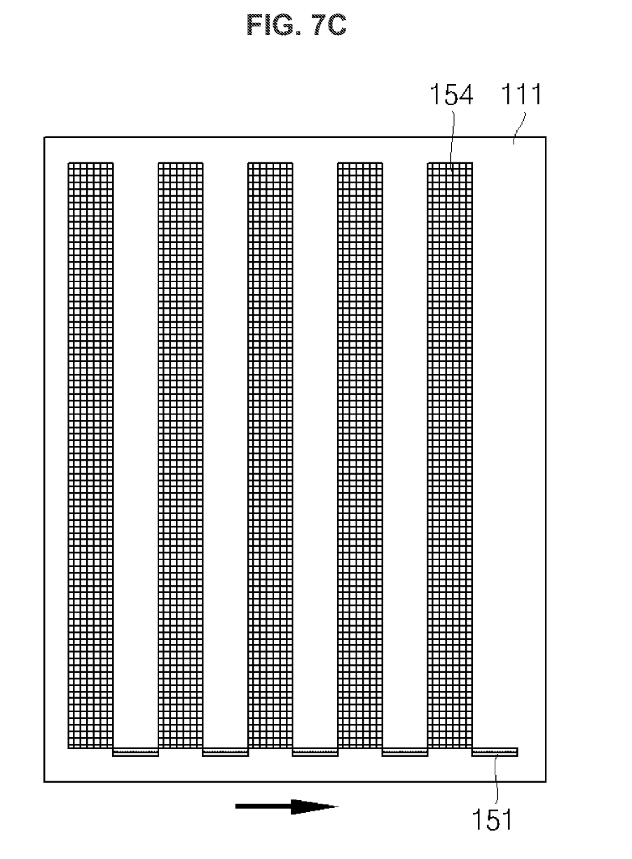

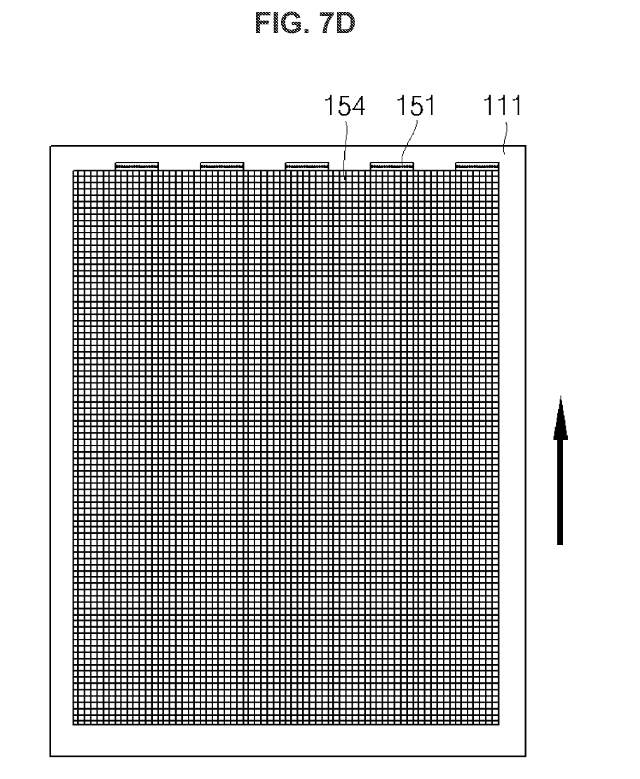

FIGS. 7A to 7D are views illustrating a sequence of printing patterns on a substrate using the heads 151 of an inkjet printer according to another embodiment of the present invention. As illustrated in FIGS. 7A to 7D, a plurality of heads 151 is spaced apart from each other by a distance (the same as the X-directional length of one head 151) along the X-direction. In this configuration, the heads 151 form a predetermined pattern 154 (for example, a color filter, an electromagnetic wave shielding filter, a black matrix, an organic thin film, or an inorganic thin film) on a substrate 111 by injecting ink while moving toward the front.

If the pattern is formed from the rear to the front of the substrate in this way, after the heads 151 temporarily stop injection of ink, the heads 151 are moved to the right by the X-directional length of one head 151 as illustrated in FIG. 7C. In other words, the heads 151 are moved to a region of the substrate 111 that has not been printed.

Thereafter, as illustrated in FIG. 7D, the heads 151 are moved to the rear side to form a predetermined pattern 154 in a region of the substrate 111 that has not been printed. In other words, the heads of the inkjet printer are moved to the front to form a pattern over a half region of the substrate 111, and are moved to the rear to form a pattern 154 over the remaining half region of the substrate 111.

As mentioned above, the inkjet printer heads 151 should not be tilted by an angle, and the Y-directional positions and the X-directional positions of the heads 151 should be accurately arranged to properly perform a printing operation as illustrated in FIGS. 7A to 7D. According to aspects of the present invention, the tilting angles and X-directional positions of the heads 151 are mechanically corrected and the Y-directional positions of the heads 151 are corrected by properly controlling the ink injection times.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An inkjet printer head arranging method comprising:
forming ink droplets on a substrate by arranging a plurality of heads in a row and injecting ink to the substrate through the heads;
sensing the positions of the ink droplets formed on the substrate;
calculating the positions of the sensed ink droplets;
calculating position correction values for the heads using the positions of the calculated ink droplets; and
correcting the positions of the heads using the calculated position correction values of the heads.

2. The inkjet printer head arranging method of claim 1, wherein the Y-direction is the direction of printing on a substrate and in sensing the positions of the ink droplets, the Y-directional positions of ends of the ink droplets corresponding to one head are sensed.

3. The inkjet printer head arranging method of claim 1, wherein the Y-direction is the direction of printing on a substrate and in sensing the positions of the ink droplets, the Y-directional positions of facing ends of the ink droplets in two regions corresponding to adjacent heads are sensed.

4. The inkjet printer head arranging method of claim 1, wherein the X-direction is the direction perpendicular to printing on a substrate and in sensing the positions of the ink droplets, the X-directional positions of facing ends of the ink droplets in two regions corresponding to adjacent heads are sensed.

5. The inkjet printer head arranging method of claim 1, wherein:
the Y-direction is the direction of printing on a substrate,
the X-direction is the direction perpendicular to printing on a substrate, and
in calculating the positions of the heads, at least one of the tilting angle relative to the Y-direction, the Y-directional position, and the X-directional position of the sensed ink droplets is calculated.

6. The inkjet printer head arranging method of claim 1, wherein the Y-direction is the direction of printing on a substrate and in calculating the positions of the heads, the tilting angle of the ink droplets is calculated by calculating the Y-directional positions of ink droplet positions at opposite ends of one ink droplet formation unit.

7. The inkjet printer head arranging method of claim 1, wherein the Y-direction is the direction of printing on a substrate and in calculating the positions of the heads, the Y-directional height difference between ink droplets of two adjacent ink droplet formation units is calculated by calculating Y-directional positions of facing ends of the ink droplets of the two adjacent ink droplet formation units.

8. The inkjet printer head arranging method of claim 1, wherein the X-direction is the direction perpendicular to printing on a substrate and in calculating the positions of the heads, the X-directional distance between ink droplets of two adjacent ink droplet formation units is calculated by calculating X-directional positions of facing ends of the ink droplets of the two adjacent ink droplet formation units.

9. The inkjet printer head arranging method of claim 1, wherein:
the Y-direction is the direction of printing on a substrate,
the X-direction is the direction perpendicular to printing on a substrate, and
in calculating position correction values for the heads, at least one of the tilting angles relative to the Y-direction, Y-directional positions, and X-directional positions of the heads is calculated.

10. The inkjet printer head arranging method of claim 1, wherein
the Y-direction is the direction of printing on a substrate,
the X-direction is the direction perpendicular to printing on a substrate, and
in correcting the positions of the heads, at least one of the tilting angles relative to the Y-direction and X-directional positions of the heads is corrected.

11. The inkjet printer head arranging method of claim 1, wherein the Y-direction is the direction of printing on a substrate and in correcting the positions of the heads, the Y-directional positions of the heads are corrected by making the injection times of the heads different.

12. An inkjet printer head arranging apparatus comprising:
an ink droplet formation unit forming ink droplets on a substrate by arranging a plurality of heads in a row and injecting ink to the substrate through the heads;
a sensing unit sensing the positions of the ink droplets formed on the substrate;
a position calculation unit calculating the positions of the captured ink droplets;
a correction value calculation unit calculating position correction values for the heads using the positions of the calculated ink droplets; and
a position correction unit correcting the positions of the heads using the calculated position correction values of the heads.

13. The inkjet printer head arranging apparatus of claim 12, wherein the Y-direction is the direction of printing on a substrate and the sensing unit senses the Y-directional positions of ends of the ink droplets corresponding to one head.

14. The inkjet printer head arranging apparatus of claim 12, wherein the Y-direction is the direction of printing on a substrate and the sensing unit senses the Y-directional positions of facing ends of the ink droplets in two ink droplet formation units corresponding to adjacent heads.

15. The inkjet printer head arranging apparatus of claim 12, wherein the X-direction is the direction perpendicular to printing on a substrate and the sensing unit senses the X-directional positions of facing ends of the ink droplets in two ink droplet formation units corresponding to adjacent heads.

16. The inkjet printer head arranging apparatus of claim 12, wherein:
the Y-direction is the direction of printing on a substrate,
the X-direction is the direction perpendicular to printing on a substrate, and
the position calculation unit calculates at least one of the tilting angle relative to the Y-direction, the Y-directional position, and the X-directional position of the sensed ink droplets.

17. The inkjet printer head arranging apparatus of claim 12, wherein the Y-direction is the direction of printing on a substrate and the position calculation unit calculates the tilting angle of the ink droplets by calculating the Y-directional positions of ink droplets at opposite ends of one ink droplet formation unit.

18. The inkjet printer head arranging apparatus of claim 12, wherein the Y-direction is the direction of printing on a substrate and the position calculation unit calculates the Y-directional height difference between ink droplets of two adjacent ink droplet formation units by calculating Y-directional positions of facing ends of the ink droplets of the two adjacent ink droplet formation units.

19. The inkjet printer head arranging apparatus of claim 12, wherein the X-direction is the direction perpendicular to printing on a substrate and the position calculation unit calculates the X-directional distance between ink droplets of two adjacent ink droplet formation units by calculating X-directional positions of facing ends of the ink droplets of the two adjacent ink droplet formation units.

20. The inkjet printer head arranging apparatus of claim 12, wherein:
the Y-direction is the direction of printing on a substrate,
the X-direction is the direction perpendicular to printing on a substrate, and
the correction value calculation unit calculates at least one of the tilting angles relative to the Y-direction, Y-directional positions, and X-directional positions of the heads.

21. The inkjet printer head arranging apparatus of claim 12, wherein:
the Y-direction is the direction of printing on a substrate,
the X-direction is the direction perpendicular to printing on a substrate, and
the position correction unit corrects at least one of the tilting angles relative to the Y-direction and X-directional positions of the heads.

22. The inkjet printer head arranging apparatus of claim 12, wherein the Y-direction is the direction of printing on a substrate and in correcting the positions of the heads, the Y-directional positions of the heads are corrected by making the injection times of the heads different.
